(19) United States
(12) Patent Application Publication
(10) Pub. No.: US 2019/0311348 A1
(43) Pub. Date: Oct. 10, 2019

(54) NETWORK FUND MANAGEMENT SYSTEM

(71) Applicants: Kang Hwa LEE, Cheongju-si (KR); Sung Jae Han, Cheongju-si (KR)

(72) Inventors: Kang Hwa LEE, Cheongju-si (KR); Sung Jae Han, Cheongju-si (KR)

(21) Appl. No.: 16/163,608

(22) Filed: Oct. 18, 2018

(30) Foreign Application Priority Data
Apr. 10, 2018 (KR) 10-2018-0041512

(51) Int. Cl. G06Q 20/22; G06Q 20/14; G06Q 20/12

(52) U.S. Cl. CPC G06Q 20/29; G06Q 30/0601; G06Q 20/127; G06Q 20/14

(57) ABSTRACT

The present invention is an object to provide fund management system which manages a network fund or capital by inheriting the Korean indigenous traditions, such as Pumashi, Dure or Gye, based on the co-existence, respect and consideration of others.

The present invention relates to a network fund management system comprising: a user terminal accessible to a service proving service through the network; a service providing server to provide fund management; a database (DB) to store necessary data for the fund management; and an online shopping mall connected to the service providing server through the network.

### TECHNICAL FIELD

The present invention relates to a network fund management system, and more particularly, to a network fund management system, to realize fund management in a type of win-win corporation among network-based members.

### BACKGROUND ART

In the traditional society of the Republic of Korea, the values of co-existence, respect and consideration with other people were important. The co-existence with others and the respect and consideration of others were continued, in the Korean traditional society, in the types of meetings, such as “Pumasi”, which is a labor-exchange, “Dure” which is a farmers' cooperative group, or “Gye” which is a kind of traditional private fund popular among Koreans, to seek the profit of small groups for the socially weak including a single person and others. These days, some autonomous communities have tried to develop and activate cooperative unions. A cooperative union is a kind of a small-sized autonomous organization which is formed by the people gathered to meet their common economical, social and cultural needs and desires through a business which is jointly owned and democratically operated.

“Pumashi” is known as a Korean indigenous custom of one-to-one exchanging labor without paying wages for labor. Usually, Pumashi is organized by a village unit. Under this organization, it is possible to ask neighbors for help often when labor is needed. Trust is preconditioned to the labor exchange of people. Pumashi is a name of the Korean indigenous custom which is performed based on trust and compassion without calculating an actual value of an individual's labor and by acknowledging a private situation of a participant.

“Dure” is a joint labor organization which country residents have by a village or town as a unit, to jointly do farm-work in a farming area. Dure is also the organization that all farmers of a village all together do group work without distinguishing between oneself and others about a farmland of the village. Dure is a type of joint labor to give and take where wages are paid later based on a cultivated acreage of each house and labor. “Gye” is known as an organization which is intentionally formed by the willing participation and promise of the members, to perform and achieve a certain purpose as a Korean traditional cooperative organization.

As described above, joint labor and joint meetings with the feature of cooperative work were regarded as important in the Korean traditional society. However, such Korean customs as described above have gradually disappeared in the Korean modern society in which individualism is now stressed. Even though a household's capital is invested in finance, since actual interest earnings are very low due to an interest rate reduction policy based on the global economic depression and economic recession, a new fund management plan is needed to be helpful for family income. In this regard, the relevant plans include, for example, Korean Patent Registration No. 1546256 entitled “System and method for funeral service based on Dure” and Korean Patent Registration No. 1309102 entitled “Moving portal server for providing moving cooperation service and method for providing the moving cooperation service thereof.”

Further, together with a safe fund management plan for an individual, a new fund management plan is needed for the social contribution for the socially weak, the settlement of the sound civic life culture, the youth crime prevention action, the educational contribution activities such as school safety, etc., the public service and rescue activities for disasters, and the social service activities including the conflict resolution among social member classes and the social participation activities.

### DISCLOSURE

### Technical Problem

Therefore, it is an object of the present invention to solve the above problems and to provide fund management system which manages a network fund or capital by inheriting the Korean indigenous traditions, such as Pumashi, Dure or Gye, based on the co-existence, respect and consideration of others.

### Technical Solution

The present invention provides a network fund management system, comprising: a user terminal accessible to a service proving service through the network; a service providing server to provide fund management; a database (DB) to store necessary data for the fund management; and an online shopping mall connected to the service providing server through the network, wherein the user terminal includes an application (APP) communicating with the service providing server so that a user registers as a member in the service providing server through the application (APP), the server forms a plurality of first groups each composed of at least seven (7) users registering as the members and records, in the database (DB), the user registered as the member to belong to one of the first groups; checks whether an initiation (registration) fee has been paid by each of the users of each of the first groups stored in the database (DB); provides, in cash, a part of the paid initiation (registration) fee to the user who registered a new member in the service providing server, among the users of each first group, who all paid the initiation (registration) fees, in the order that each user registered as the member; and provides a point available in the shopping mall together with a repayment of the fund.

Preferably, a person recommended by the user to receive the repayment of the fund is arranged as the last order to receive the repayment of the fund in the same group that the user recommending the person belongs to, and the order of the user to receive the repayment of the fund is rearranged to the last order to receive the repayment of the fund in the same group.

Preferably, when the user receives the repayments of the fund by three (3) times, the server forms a plurality of second groups each composed of at least ten (10) users registering as the members and records, in the database (DB), the user received the three (3)-time repayments of the fund to belong to one of the second groups, checks whether an initiation (registration) fee has been paid by each of the users of each of the second groups stored in the database (DB); provides, in cash, a part of the paid initiation (registration) fee to the user who registered a new member in the service providing server, among the users of each second group, who all paid the initiation (registration) fees, in the order that each user registered as the member; and provides a point available in the shopping mall together with a repayment of the fund.

Preferably, when a new member is registered by the recommendation of the user, the server further pays an extra payment for the recommendation to the relevant user.

### Advantageous Effects

According to the present invention as described above, a network fund management system enables the planning of a safe profit for an investor by inheriting the Korean indigenous traditions, such as Pumashi, Dure or Gye, based on the co-existence, respect and consideration of others, and by pursuing a win-win situation with others.

### DESCRIPTION OF DRAWINGS

The above and other features and advantages of the present invention will become more apparent by describing in detail exemplary embodiments thereof with reference to the attached drawing(s) in which:

FIG. 1 shows one example of a network fund management system according to the present invention;

FIG. 2 shows a system to illustrate a management method of a first group in the network fund management system according to the present invention;

FIG. 3 shows a system to illustrate a management method of a second group in the network fund management system according to the present invention; and

FIG. 4 is a flow chart of the operation in the network fund management system according to the present invention.

### DESCRIPTION OF NUMBERS FOR CONSTITUENTS IN DRAWINGS

10: APP server
20: user terminal
30: shopping mall
40: DB

### MODE FOR INVENTION

The present invention will now be described more fully hereinafter with reference to the accompanying drawing(s), in which preferred embodiments of the invention are shown. This invention may, however, be embodied in many alternate forms and should not be construed as limited to only the embodiments of the present invention set forth herein.

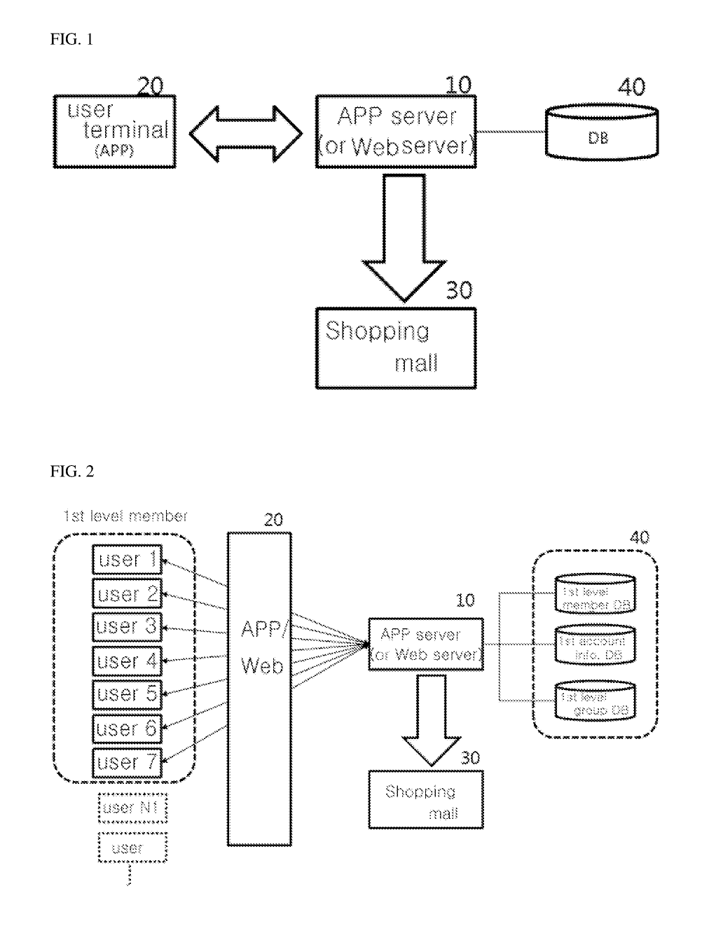

FIG. 1 is a schematic diagram of one example of a network fund management system according to the present invention. As shown in FIG. 1, the network fund management system comprises: a user terminal with an application (APP) 20 enabling communication with a server can be installed; an application (APP) server 10 providing a fund service according to the present invention; a database 40 storing necessary information in the APP server 10; and an internet shopping mall 30 operatively connected to the APP server 10.

A user is provided with the fund service after signing up for a membership by accessing to the APP server 10 or web server 10 using a mobile terminal, such as a smart phone, tablet PC, etc., or a computer, such as a notebook PC, desktop PC, etc.

The APP server 10 providing the fund service receives identifier information, for example, ID information, from the user terminal with the application (APP) 20 and provides the fund service based on the relevant user's level. The user information, user account information and transaction information required in operating the web server or APP server 10 are stored in the database 40.

The shopping mall 30 is an internet-based shopping mall. The web server or APP server 10 transfers an exclusive shopping mall point, which is assigned to the user, to the shopping mall 30 and the user purchases goods from the shopping mall by using the assigned point.

FIG. 2 illustrates the network fund management system with respect to a first level member, based on FIG. 1. A first level management is basically applied to the first level member among the people registered as members of the fund service according to the present invention.

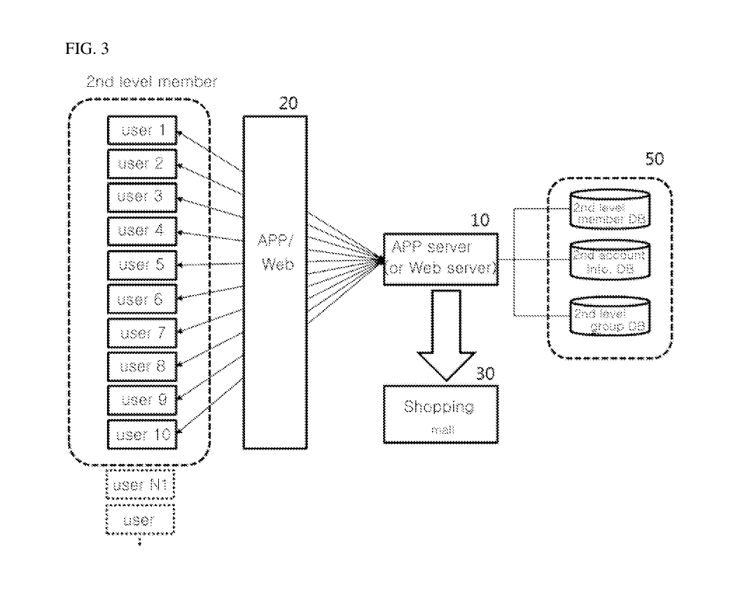

The fund management service according to the present invention is provided by being basically divided into a first level member group (for example, an associate member group) and a second level member group (for example, a regular member group). As described above, FIG. 2 illustrates the fund management service for the first level member group and FIG. 3 illustrates the fund management service for the second level member group.

At a step of initially registering as a member of the fund service, the user can select whether to register as the first level member (associate member) or the second level member (regular member).

An initiation (registration) fee required when registering as the first level member may be, for example, $3,500(3,500,000 Korea Won) and an initiation (registration) fee required when registering as the second level member may be, for example, $10,000 (10,000,000 Korea Won). However, the present invention does not limit the fee and the initiation (registration) fee may be properly determined to be managed. Further, the user may selectively register as the second level member upon registering, however, the first level member may be promoted to the second level member when meeting a specific condition. The foregoing will be later described in more detail.

In FIG. 2, the fund management service for the first level member starts, based on seven (7) members. In FIG. 2, each of users 1 to 7 can be registered as a first level member in the APP server or web server 10 through the user terminal with the application 20, assuming that each user has paid the imitation (registration) fee of $3,500 (3,500,000 Korea Won) to the web server 10 through a back transaction. The web server 10 manages a group of the first level members composed of the seven (7) users.

The web server 10 operates the fund service based on the initiation (registration) fee. 35% of the initiation (registration) fee is separately saved for payment for user in a first account of a corporation, 10% is separately saved for extra payment for recommendation in a second account, 35% is saved or paid for supplying or manufacturing goods to be provided to the shopping mall 30, 3% is saved as an operating fund for the fund service in a separate account, and 17% is saved for tax payment in a separate account.

The web server 10 further includes a first level member DB recording each individual member information, a first account information DB recording each member account information and shopping mall point information, and a first level group DB recording information of the group of the first level members.

More specifically, in FIG. 2, each of the users is registered in the first level member DB, the information of the initiation (registration) fee as paid is recorded in the first account information DB, and the information regarding which group each user belongs to and the date of registering as a member, etc., is recorded in the first level group DB, for tracking management.

Basically, the fund service according to the present invention is operated in the same structure of the Korean traditional custom “Gye”. The members of the group composed of users 1 to 7 receive the fund in order, based on the dates of registering as a member, with the condition whether the user has recommend a new user.

When one group composed of seven (7) users is completed and all of the users have paid the initiation (registration) fees, the server 10 performs a process of providing the funds to the users of the group in order. To this end, the serve 10 informs that the one group has been completed through the users' application 20 or the phone information recorded upon registering as a member and notifies the users to recommend a new member to receive the funds.

The users receiving the notice mentioned above try to register at least one new user (user N1) who wants to participate in the relevant group in the APP server 10 through the application 20. When a new member, that is, a new user N1, registers as a member in the server 10, (s)he describes the ID of the recommender so that the APP server 10 knows which user recommends how many new users and further provides an additional award with the fund.

In FIG. 2, when the users register as a member in the order of user 1 to user 7, the APP server 10 notifies the user 1 to recommend a new user within a certain period and the user 1 should recommend a new user within the certain period.

When the user 1 recommends a new user N1 within the certain period, the APP server 10 records the information of the new user N1 in database, recording an update on the recommendation information of the user 1 in the database, includes the recommended new user N1 in the group to which the user 1 belongs and records the foregoing in the database.

After the registration of the new member is approved in the APP server or service providing server (for example, by the payment of the initiation (registration) fee), the server arranges the new user N1 after the user 7 and provides a repayment of the fund (for example, $5,000 (50,000,000 Korea Won) in cash) to the user 1, with a point (for example, $3,500 (35,000,000 Korea Won) in cash) which is usable in the shopping mall 30. The information of the cash and point paid to the user 1 is recorded in the first level member DB and the first account information DB.

When the repayment of the fund and the payment of the shopping mall point to the user 1 are completed, the APP server or service providing server proceeds with the aforementioned process regarding the user 2 and repeats the processes up to the user 7.

An interval between the repayments of the funds to the user 1 and the user 2 is not specifically set. When the user does not recommend any new member until his particular turn, the repayment of the fund to the user is postponed and it is for the next user in turn. For example, when the user 3 does not register a new member who (s)he recommends in the server, the APP server 10 holds the repayment of the fund to the user 3 and proceeds with the aforementioned process to the user 4 which is the next turn.

When each of the users 1 to 7 normally recommends one (1) person, respectively, the number of new users N1˜N7 who are newly registered by the users 1 to 7 totals seven (7) and the relevant group includes fourteen (14) people. In this case, the number of new members to be recommended by the existing user is not limited. When the existing user recommends more than one (1) new user, the extra payment for recommendation is provided. The extra payment for recommendation is additionally paid by $350 (350,000 Korea Won) which is 10% of the initiation (registration) fee of $3,500 (3,500,000 Korea Won).

In the example described above, although the users 1 to 7 in order recommend new members, the present invention is not limited to such an order for convenience. The users 1 to 7 may recommend new members, irrelevant to the order of the users 1 to 7. The APP server determines whether to pay the repayment of the fund by counting the number of new users recommended, based on the user information DB.

For example, when the user at first receives the repayment of the fund, (s)he is able to receive it if at least one (1) new member is recommended; when the user secondly receives the repayment of the fund, it is required that at least two (2) new members are recommended; and when the user thirdly receives the repayment of the fund, it is required that at least three (3) new members are recommended.

The first level member may receive a total of three (3)-time repayments of the fund ($15,000 (15,000,000 Korea Won)) and a shopping mall gift card correspond to a total of $10,500 (10,500,000 Korea Won) through the initiation (registration) fee of $3,500 (3,500,000 Korea Won). Further, if any additional new members are recommended, an extra reward of $350 (350,000 Korea Won) per person is given.

Further, the first level member is qualified as the second level member after receiving the total of three (3) times of the repayment of the fund. Whether to be elevated as the second level member is determined based on an agreement of registering as the second level member provided on the user terminal with the application 20.

Further, even if the members initially registered are elevated as the second level members and excluded from the group, since the relevant group is continuously maintained by the generation of new members registered by the first level members and by another generation of new members registered by the previous new members, it is possible to prevent a risk that the aforementioned repayments of funds and gift cards would not be provided to the user in turn of receiving the repayment of the fund.

In FIG. 3, the fund management service according to the present invention is described with respect to the second level member group. FIG. 3 illustrates the fund service to the second level member group.

Referring to FIG. 3, a user registers as the second level member (regular member) when initially registering as a member of the fund service, or when the first level member receives three-time repayments of the fund, (s)he is elevated as the second level member.

An initiation (registration) fee required when registering as the second level member may be, for example, $10,000 (10,000,000 Korea Won). However, the present invention does not limit the aforementioned fee and the initiation (registration) fee may be properly selected to be applied.

In FIG. 3, the fund service to the second level member starts a group composed of ten (10) users, unlike the first level member group basically composed of seven (7) users. In FIG. 3, each of users 1 to 10 can register as the second level member in an APP server 10 through a user terminal with an application 20, assuming that each paid the initiation (registration) fee of $10,000 (10,000,000 Korea Won) to the web server 10 through a back transaction. The web server 10 manages the second level members composed of ten (10) users as one group.

Further, in the case of the second level member, (s)he needs to have a designated deposit of $10 (10,000 Korea Won) or more every month to a donation organization registered in the APP server, for example, “Fruits of Love”, by designating an object to receive a donation to achieve the social contribution and needs to submit an affidavit thereof through the application 20. Since the second level member is given the qualification for the regular member of the fund service according to the present invention, (s)he has a right to participate in a general meeting and has a right to resolution and vote.

The server 10 operates the fund service based on the initiation (registration) fee. 30% of the initiation (registration) fee is separately saved for repayment of fund for user in a first account of a corporation, 10% is separately saved for extra payment for recommendation of a new member in a second account, 35% is saved or paid for supplying or manufacturing goods to be provided to the shopping mall 30, 8% is saved as an operating fund for the fund service in a separate account, and 17% is saved for tax payment in a separate account.

The web server 10 further includes a second level member DB recording each individual member information, a second account information DB recording account information and shopping mall point information of each second level member, and a second level group DB recording information of the group of the second level members.

More specifically, in FIG. 3, each of the users is registered in the second level member DB, the information of the initiation (registration) fee as paid is recorded in the second account information DB, and the information regarding which group each user belongs to and the date of registering as a member, etc., is recorded in the second level group DB, for tracking management.

Basically, the fund service according to the present invention is operated in the same structure of the Korean traditional custom “Gye”. The members of the group composed of users 1 to 10 receive the fund in order, based on the dates of registering as the second level member, with the condition whether the user has recommend a new user, like the first level member.

When one group composed of ten (10) users is completed and all of the users have paid the initiation (registration) fees, the server 10 performs a process of providing the funds to the users of the group in order. To this end, the serve 10 informs that the one group has been completed through the users' application 20 or the phone information recorded upon registering as a member and notifies the users to recommend a new member to receive the repayment of funds.

The users receiving the notice mentioned above try to register at least one new user (user N1) who wants to participate in the relevant group in the APP server 10 through the application 20. When a new user N1, registers as a member in the server 10, (s)he describes the ID of the recommender so that the APP server 10 knows which user recommends how many new users and further provides an additional award with the repayment of the fund.

In FIG. 3, when the users register as a member in the order of the users 1 to 10, the APP server 10 notifies the user 1 to recommend a new user within a certain period and the user 1 should recommend a new user within the certain period.

When the user 1 recommends a new user N1 within the certain period, the APP server 10 records the information of the new user N1 in database, recording an update on the recommendation information of the user 1 recommending the new member to be record in the database, includes the new user N1 as a new member in the group to which the user 1 belongs and records the foregoing in the database.

After the registration of the new member is approved in the APP server or service providing server (for example, by the payment of the initiation (registration) fee), the server arranges the new user N1 after the user 10 and provides a repayment of the fund (for example, $20,000 (20,000,000 Korea Won) in cash) to the user 1, with a point (for example, $10,000 (10,000,000 Korea Won) in cash) which is usable in the shopping mall 30. The information of the cash and point paid to the user 1 is recorded in the second level member DB and the second account information DB.

When the repayment of the fund and the payment of the shopping mall point to the user 1 are completed, the APP server or service providing server proceeds with the aforementioned process regarding the user 2 in the next turn and repeats the processes up to the user 10.

A time interval between the repayments of the funds to the user eligible for the present fund payment and the user eligible for the next fund payment is not specifically set. When the user does not recommend any new member until his particular turn, the repayment of the fund to the user is postponed and it is for the next user in turn. For example, when the user 3 does not register a new member who (s)he recommends in the server, the APP server 10 holds the repayment of the fund to the user 3 and proceeds with the aforementioned process to the user 4 which is the next turn.

When each of the users 1 to 10 normally recommends one (1) person, respectively, the number of new users N1˜N10 who are newly registered by the users 1 to 10 totals ten (10) and the relevant group includes twenty (20) people. In this case, the number of new users to be recommended by the existing user is not limited. When the existing user recommends more than one (1) new user, the extra payment for recommendation is provided. The extra payment for recommendation is additionally paid by $1,000 (1,000,000 Korea Won) which is 10% of the initiation (registration) fee of $10,000 (10,000,000 Korea Won).

In the example described above, although the users 1 to 10 in order recommend new members, the present invention is not limited to such an order, for convenience. The users 1 to 10 may recommend new members, irrelevant to the order of the users 1 to 10. The APP server determines whether to pay the repayment of the fund by counting the number of new users recommended, based on the user information DB.

For example, when the user at first receives the repayment of the fund, (s)he is able to receive it if at least one (1) new member is recommended; when the user secondly receives the repayment of the fund, it is required that at least two (2) new members are recommended; and when the user thirdly receives the repayment of the fund, it is required that at least three (3) new members are recommended.

The number of the repayments of the fund received by the second level member is not limited, unlike the first level member who can possibly receive the three (3) time repayments of the fund. For example, the second level member can receive the repayment of the fund of $20,000 (20,000,000 Korea Won) in cash by one time, together with a shopping mall point of $10,000 (10,000,000 Korea Won). When the second level member recommends a new member, (s)he can receive an extra reward of $1,000 (1,000,000 Korea Won) per new member recommended.

Further, in FIG. 2 and FIG. 3, the goods manufactured or purchased by the APP server or service providing server 10 may be delivered to the shopping mall 30. However, the goods directly manufactured or produced by the members may be supplied to the shopping mall 30 or the website(s) of the goods currently sold by the members may be connected to the shopping mall 30, to strengthen the friendship among the members and further promote the mutual benefits.

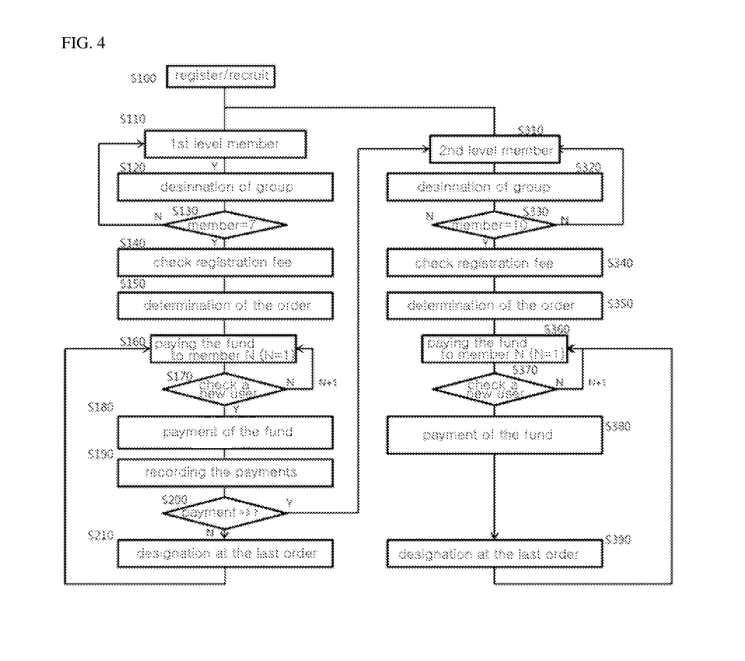

FIG. 4 is a flow chart of the network fund management service according to the present invention.

In FIG. 4, at S100, a user registers as a member by accessing to an APP server 10 through a user terminal with an application 20.

It is possible for the user to register as a first level member or a second level member. The fund management service starts at S110 in case of registering as the first level member or at S310 in case of registering as the second level member.

In the case of registering as the first level member, the server designates a group with respect to the first level member at S110 and checks whether the minimum number of users to form a group of the first level member is completed as seven (7) at S130. When the number of the first level members is seven (7), the process continues at S140. Otherwise, the process returns at S110 to wait for another user to register as a member.

At S140, the server checks whether an initiation (registration) fee has been paid for each of the seven (7) members for the first level member group. If the initiation (registration) fees have been paid, at S150 the order that the user receives a repayment of the fund within the group is determined based on the order that the users register as the members.

After the order to receive the repayment of the fund has been determined at S150, at S160 the server performs a process of providing the repayment of the fund for the user who is in a first order (N=1). As a condition to receive the repayment of the fund, at S170 the server checks whether any new member is recommended by the user (N=1) in the relevant order.

When the new member recommended is confirmed at S170, the server proceeds with S180 to provide the repayment of the fund to the user (N=1) and to designate the new member recommend by the user (N=1) to be in a next order following the order (N=7), and with S190 to count the number of the repayments of the fund which have been paid to the relevant user.

When the number of the repayments of the fund paid to the relevant user is in excess of three (3) times, at S200 the server elevates the user as the second level member like S310. However, when the number of the repayments of the fund paid to the relevant user is less than three (3) times, at S210 the server arranges the order of the relevant user who received the repayment(s) of the fund to the last order at the point of time when the user received the repayment(s) of the fund, and returning to S160, the server performs the process of providing the repayment of the fund to the user in the next order.

In the same manner at S170, when no new member is recommended by the user in the relevant order (for example, N=1), the server performs the process of providing the repayment of the fund to the user in the next order (N=N+1).

At S310, the server for the second level member is provided. At S320, the server designates a group for the user registering as the second level member. At S330, the server checks whether the minimum number of the second level members is ten (10) to form the second level member group. If the number of the first level members is ten (10), the process continues at S340. Otherwise, the process returns at S310 to wait for another user to register as a member.

At S340, the server checks whether an initiation (registration) fee has been paid for each of the ten (10) members for the first level member group. If the initiation (registration) fees have been paid, at S350 the order that the user receives a repayment of the fund within the group is determined based on the order that the users register as the members.

After the order to receive the repayment of the fund has been determined at S350, at S360 the server performs a process of providing the repayment of the fund for the user who is in a first order (N=1). As a condition to receive the repayment of the fund, at S370 the server checks whether any new member is recommended by the user (N=1) in the relevant order.

When the new member recommended is confirmed at S370, the server proceeds with S380 to provide the repayment of the fund to the user (N=1) and to designate the new member registered by the user (N=1) to be in a next order following the order (N=10), and with S390 to arrange the order of the user who received the repayment of the fund to the last order at the point of time when the user received the repayment of the fund, moving at S360 to perform the process of providing the repayment of the fund to the user in the next order.

In the same manner at S370, when no new member is registered by the user in the relevant order (for example, N=1), the server performs the process of providing the repayment of the fund to the user in the next order (N=N+1).

While the present invention has been particularly shown and described with reference to examples thereof, it will be understood by those of ordinary skill in the art that various modifications and alternative arrangements in form and details may be made therein without departing from the spirit and scope of the present invention as defined by the following claims. The scope of the claims, therefore, should be accorded the broadest interpretation so as to encompass all such modifications and similar arrangements.

1. A network fund management system comprising:
a user terminal accessible to a service proving service through the network;
a service providing server to provide fund management;
a database (DB) to store necessary data for the fund management; and
an online shopping mall connected to the service providing server through the network,
wherein
the user terminal includes an application (APP) communicating with the service providing server so that a user registers as a member in the service providing server through the application (APP),
the server forms a plurality of first groups each composed of at least seven (7) users registering as the members and records, in the database (DB), the user registered as the member to belong to one of the first groups; checks whether an initiation (registration) fee has been paid by each of the users of each of the first groups stored in the database (DB); provides, in cash, a part of the paid initiation (registration) fee to the user who registered a new member in the service providing server, among the users of each first group, who all paid the initiation (registration) fees, in the order that each user registered as the member; and provides a point available in the shopping mall together with a repayment of the fund.

2. The network fund management system in claim 1, wherein a person recommended by the user to receive the repayment of the fund is arranged as the last order to receive the repayment of the fund in the same group that the user recommending the person belongs to.

3. The network fund management system in claim 2, wherein the order of the user to receive the repayment of the fund is rearranged to the last order to receive the repayment of the fund in the same group.

4. The network fund management system in claim 3, wherein, when the user receives the repayments of the fund by three (3) times, the server forms a plurality of second groups each composed of at least ten (10) users registering as the members and records, in the database (DB), the user received the three (3)-time repayments of the fund to belong to one of the second groups, checks whether an initiation (registration) fee has been paid by each of the users of each of the second groups stored in the database (DB); provides, in cash, a part of the paid initiation (registration) fee to the user who registered a new member in the service providing server, among the users of each second group, who all paid the initiation (registration) fees, in the order that each user registered as the member; and provides a point available in the shopping mall together with a repayment of the fund.

5. The network fund management system in claim 4, wherein, when a new member is registered by the recommendation of the user, the server further pays an extra payment for the recommendation to the relevant user.
